(19) United States
(12) Patent Application Publication
(10) Pub. No.: US 2006/0022512 A1
(43) Pub. Date: Feb. 2, 2006

(54) Tire dressing spray cover

(76) Inventor: Christopher Wood, The Colony, TX (US)

Correspondence Address: Robert C. Klinger;Jackson Walker LLP, Suite 600, 2435 North Central Expressway, Richardson, TX, 75080, US

(21) Appl. No.: 10/909,831

(22) Filed: Aug. 2, 2004

(51) Int. Cl. B60B 7/00

(52) U.S. Cl. 301/37.104

(57) ABSTRACT

A selectively configurable tire dressing cover adapted to be juxtaposed over a wheel rim to protect it during the application of tire dressing substances, such as sprays, foams and other solutions. The cover comprises a handle portion, and a plurality of interchangeable protective members each having a different outer diameter commensurate with the diameter of the respective wheel rim. Each removable protective cover is adapted to be juxtaposed to the wheel rim outer edge of like diameter so as to cover and protect the wheel rim during application of the tire dressing.

### FIELD OF THE INVENTION

The present invention is generally related to automotive accessories, and more particularly to devices adapted to dress automotive tires with sprays, foams and liquids.

### BACKGROUND OF THE INVENTION

The wheel and tire business is a five billion dollar a year industry. Tire dressing foams, sprays, and other liquids are typically used to enhance the appearance of the tire, giving the rubber a darker color and more luster.

Typically, these tire dressings are rather messy to apply, and unfortunately, often are unintentionally applied to the wheel rim, which then needs to be subsequently cleaned of the dressing to improve its appearance and prevent other contaminates from adhering to the rim.

There is a need to provide a quicker and less messy apparatus and method for dressing a tire with sprays, liquids, foams and other dressings.

### SUMMARY OF THE INVENTION

The present invention achieves technical advantages as a selectively configurable dressing cover adapted to be juxtaposed over a wheel rim to protect it during the application of tire dressing substances, such as sprays, liquids, foams and other solutions. In one embodiment, the invention comprises a handle portion, and a plurality of interchangeable protective members having different outer diameters commensurate with the diameter of the wheel rims. The removable protective covers are each adapted to be juxtaposed to a wheel rim of like diameter so as to cover and protect the wheel rim during application of dressing.

In one preferred embodiment of the present invention, the tire dressing apparatus includes a handle having an attachment portion. At least one removable protective member is adapted to be selectively attached to the handle attachment portion, the protective member having a circular edge adapted to be juxtaposed to the wheel rim edge so as to cover the wheel rim. The handle attachment portion preferable comprises an annular recess, and the removable protective member is defined as an annular ring adapted to be secured to the annular recess and configured about the edge of the handle. The removable protective member may be a ring having a resilient surface adapted to face the wheel rim preventing scratching thereof during use.

A plurality of removable protective members each connectable to the handle may be provided, each having a different outer diameters such that they are configurable for use with wheel rims having different diameters. One universal handle is adaptable to each of the different protective members providing universal functionality.

### BRIEF DESCRIPTION OF THE DRAWINGS

FIG. 1 is an exploded view of one embodiment of the present invention, including a handle selectively coupled to an annular protective member shaped as a ring;

FIG. 2 is a top view of the handle coupled to a plurality of rings having different outer diameters;

FIG. 3 is a top view of the handle;

FIG. 4 is an elevational exploded view of the handle having an annular recess adapted to selectively receive one of the protective rings; and

FIG. 5 is an exploded perspective view of a second embodiment of the present invention.

### DETAILED DESCRIPTION OF THE PREFERRED EMBODIMENT

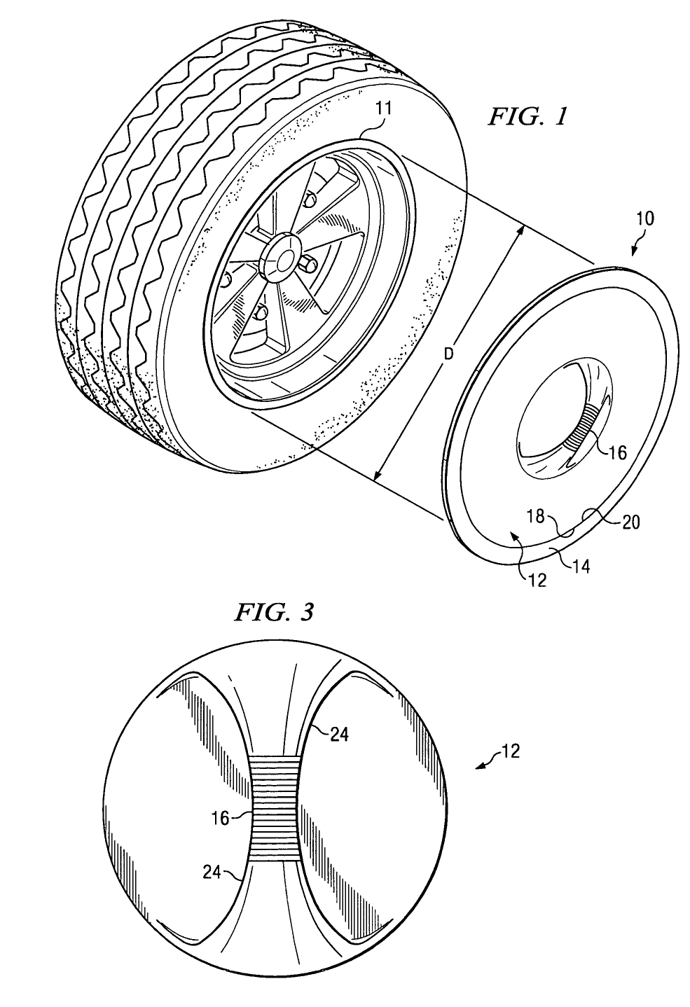

Referring to FIG. 1, there is shown an exploded view of one embodiment of the present invention seen to comprise a tire dressing apparatus 10 having an outer diameter “D” being generally the same as the outer diameter of a wheel rim generally shown at 11. The tire dressing apparatus 10 has two parts, a handle portion 12 and at least one selectively interchangeable annular protective disk member 14. The handle 12 has an upwardly arched handle gripping portion 16 extending over the central surface of the handle 12, as shown. This handle 16 is adapted to be comfortably gripped by the hand of a user. The handle 12 is seen to have an annular outer portion 18 generally conforming to an inner diameter 20 of the protective member 14.

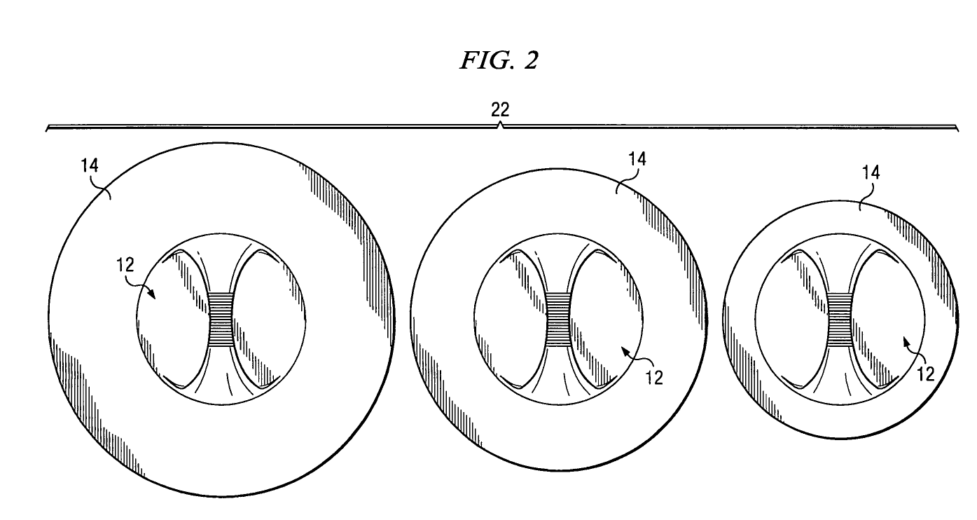

Referring to FIG. 2, there is shown at 22 the handle 12 being securable to a set of removable protective members 14 each having a different outer diameter “D”, but a common inner diameter being matable to the handle outer portion 18. Advantageously, different protective disks 14 adapted for use with a corresponding wheel rim of same diameter can each be selectively secured to the common handle 12, as shown.

Referring to FIG. 3, there is shown a top view of the handle 12 having the arched handle 16 defined by a pair of laterally inwardly concave surfaces 24.

Referring now to FIG. 4, there is shown an exploded elevational view of the handle 12 and one protective disk member 14 sectioned to shown a disk opening 26 having a diameter defined by an inner annular edge 28. As shown, the handle 12 periphery has a first securing member 30 being flanged upwardly and outwardly, with the narrower lower portion of the flange having roughly the same diameter as the disk inner edge 28, and wider upper edge forming a diameter being slightly greater than the member 14 inner edge 28 diameter. The protective disk member 14 is preferably comprised of a resilient material, such as rubber, plastic, or other resilient material, such that the disk member 14 can be slightly expanded and secured over the flanged portion 30 into a recess 32 in a friction fit arrangement.

Recess 32 is seen to be defined between the first securing member 30 and the outer handle edge 18, and having a vertical width “W” being generating the same as the width of protective disk member 14 to provide a secure attachment thereto. The inner edge 28 of protective disk member 14 forms a second attachment mechanism adapted to couple to the first securing member 30 for easy attachment to, and removal from the handle 12.

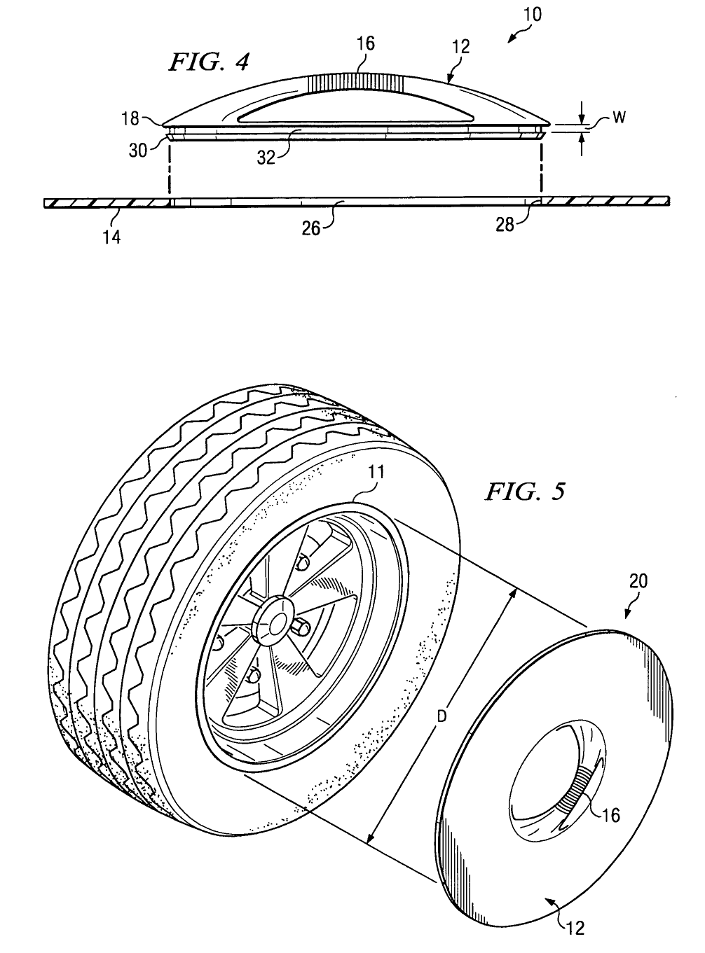

Referring now to FIG. 5, there is shown a second embodiment of the invention comprised of a unitary disk 20 having a handle 16 and fixed outer diameter. This disk 20 may have an outer diameter of, for instance, 16″ and is adapted to be juxtaposed to the wheel rim 11, as shown. The inner surface of disk 20 is resilient so as to not scratch the wheel rim 11 during use.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

We claim:

1. In combination:
a wheel rim having a first circular edge; and
a tire dressing apparatus, comprising;
a handle having a first attachment portion; and
at least one removable protective member adapted to be selectively attached to the handle attachment portion and having a second circular edge juxtaposed to the wheel rim first circular edge so as to cover the wheel rim.

2. The combination as specified in claim 1 wherein the removable protective member has a second attachment portion adapted to securingly couple to, and be releasable from, the handle first attachment portion.

3. The combination as specified in claim 2 wherein the first attachment portion comprises an annular recess.

4. The combination as specified in claim 3 wherein the annular recess has a width commensurate with a thickness of the removable protective member.

5. The combination as specified in claim 3 wherein the removable protective member is defined as an annular ring.

6. The combination as specified in claim 5 wherein the removable protective ring has a resistant surface facing the wheel rim.

7. The combination as specified in claim 1 further comprising a plurality of the removable protective members each having a different outer diameter.

8. A tire dressing apparatus for a wheel rim, comprising;
a handle having a first attachment portion; and
at least one removable protective member adapted to be selectively attached to the handle attachment portion and having a second circular edge adapted to be juxtaposed to the wheel rim so as to cover the wheel rim.

9. The apparatus as specified in claim 8 wherein the removable protective member has a second attachment portion adapted to securingly couple to, and be releasable from, the handle first attachment portion.

10. The apparatus as specified in claim 9 wherein the first attachment portion comprises an annular recess.

11. The apparatus as specified in claim 10 wherein the annular recess has a width commensurate with a thickness of the removable protective member.

12. The apparatus as specified in claim 10 wherein the removable protective member is defined as an annular ring.

13. The apparatus as specified in claim 12 wherein the removable protective ring has a resistant surface facing the wheel rim.

14. The apparatus as specified in claim 8 further comprising a plurality of the removable protective members each having a different outer diameter.

15. In combination:
a wheel rim having a first circular edge; and
a tire dressing apparatus having a handle having a second circular edge juxtaposed to the wheel rim first circular edge so as to cover the wheel rim.
